(19) United States
(12) Patent Application Publication
(10) Pub. No.: US 2016/0098325 A1
(43) Pub. Date: Apr. 7, 2016

(54) UNIFYING APPLICATION LOG MESSAGES USING RUNTIME INSTRUMENTATION

(71) Applicant: HEWLETT-PACKARD DEVELOPMENT COMPANY, L.P., Houston, TX (US)

(72) Inventors: Matias Madou, Diegem (BE); Sam Ming Sum Ng, Hong Kong (HK)

(21) Appl. No.: 14/787,814

(22) PCT Filed: Jun. 19, 2013
(86) PCT No.: PCT/US2013/046612

§ 371 Date: Oct. 29, 2015

(51) Int. Cl. G06F 11/14; G06F 11/07

(52) U.S. Cl. CPC G06F 11/1492; G06F 11/0781; G06F 11/0787; G06F 11/0712

(57) ABSTRACT

Unifying application log messages using runtime instrumentation includes capturing raw data associated as a log message from an application using an application monitoring module, determining if the raw data is to be filtered based on a filtering configuration, and constructing a log message based on the raw data. A system for unifying application log messages using runtime instrumentation includes a capture engine to capture raw data associated as a log message from an application using an application monitoring module, a determination engine to determine if the raw data is to be filtered based on a filtering configuration, a construction engine to construct a log message based on the raw data, and a log framework monitor engine to monitor an application program interface that invokes a writing action of the log message using at least one log framework to capture the log message in real time.

### BACKGROUND

Log management is the process of recording and storing log messages generated by program code in an application. An application writes log messages by calling the log framework application programming interface (API). The log framework filters and formats the log entries according to the log framework's parameters to determine an appropriate storage destination for each log message. Further, the log message is stored as a log file in an appropriate storage destination.

### BRIEF DESCRIPTION OF THE DRAWINGS

The accompanying drawings illustrate various examples of the principles described herein and are a part of the specification. The examples do not limit the scope of the claims.

FIG. 1 is a block diagram of a unifying system, according to one example of the principles described herein.

FIG. 2 is a diagram of a unifying system, according to one example of the principles described herein.

FIG. 3 is a flowchart of a method for unifying a log message in an application using runtime instrumentation, according to one example of principles described herein.

FIG. 4 is a flowchart of a method for unifying a log message in an application using runtime instrumentation, according to another example of principles described herein.

FIG. 5 is a diagram of a unifying system, according to one example of the principles described herein.

FIG. 6 is a diagram a unifying system according to one example of the principles described herein.

Throughout the drawings, identical reference numbers designate similar, but not necessarily identical, elements.

### DETAILED DESCRIPTION

A computer system may generally create or generate a log message while a program code is executing in an application to understand the activity of the computer system and potentially diagnose problems. A generated log message is stored as a log file and may be used to diagnose these potential errors within the computer system. The generated log message may include fields of data comprising time, process ID, user ID, and severity level of the problem. To generate the log message, a log framework may be used. A log framework can be used to write the log message to a log file in various formats. The log framework can also apply different filtering mechanisms for each log message in order to store a log message as a log file in a storage destination.

However, the log framework is highly customizable and can lead to a number of problems when reading log messages. For example, a log framework can be used to write a log message to a log file in different formats such as extensible markup language (XML) format, a JavaScript object notation (JSON) format, an American standard code for information interchange (ASCII) format, other formats, and combinations thereof. Further, an organization may use hundreds of log frameworks using different formats to write a number of log messages to a number of log files. As a result, reading a number of log messages in different formats can be a complicated task when trying to understand the activity of the computer system especially if too many of these different formats are used. Further, the formats can be constructed programmatically inside the application code resulting in the configuration not being available or readable.

Still further, a log framework can apply a different filtering mechanism for each log message generated. Because of the filtering mechanism, not all log messages are stored in a log storage destination. If a particular log message is filtered by the log framework, a system may not be able to see it. Since different logging frameworks have different configurations, resetting the filtering may also be challenging.

The principles described herein include a method for unifying application log messages using runtime instrumentation. Such a method includes capturing raw data associated as a log message from an application using an application monitoring module, determining if the raw data is to be filtered based on a filtering configuration, and constructing a log message based on the raw data. Further, raw data may be information in a log message generated by an application. For example, raw data may be financial information for an application used to regulate finances of a bank. Such a method allows the raw data, associated as a log message, to be captured inside an application before the raw data is filtered and formatted. Still further, such a method allows the log message to be unified by filtering and formatting the log message in a single format. As a result, it is easier to understand the activity of the computer system because all the log messages are in a single format.

The method can further include an application monitoring module as runtime instrumentation to monitor when an application is writing a log message to a log framework. The application monitoring module further monitors if an application program interface (API) on the log framework is checking if a particular log level is enabled. More information about the application monitoring module will be described below.

As used in the present specification and in the appended claims, the term “a number of” or similar language is meant to be understood broadly as any positive number comprising I to infinity; zero not being a number, but the absence of a number.

Additionally, as used in the present specification in the appended claims, the term “log file” is meant to be understood broadly as the log storage destination within a memory device. A “log file” is not limited to a regular file in a computer file system. Provided as an example, log messages can be written to a regular file, remote database, or sent to a remote syslog server, among others. Therefore, the term “log file” herein can further refer to, but is not limited to, these storage locations.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described in connection with that example is included as described, but may not be included in other examples.

Provided as an example, there are two common ways for log message filtering. The first is filtering by log level, and the second is filtering by logger name. More information about the two filtering mechanisms will be described below.

Log frameworks supporting filter by log level may use a severity level when creating a log message. For example, a logging framework may contain five different levels, namely, TRACE, DEBUG, INFO, WARN, ERROR, with TRACE being the least important level and ERROR being the most important level. When the minimum level is set to INFO, all log messages with level lower than INFO will not be written to the log file.

Similar to filter by log level, frameworks supporting filter by logger name may use a special string field, indicated as a logger name, when creating a log message. A logger name can be provided explicitly but is usually implicitly provided by the framework. For example, most logger names are automatically set to the source Class name that creates the log message. Provided as an example, if the log message is created within the Class “com.mycompany.ClassX”, then the logger name is automatically set to “com.mycompany.ClassX”. With the logger name, the logging framework can apply fine-grained filter on the logs. For example, a configuration can specify TRACE level from certain logger source and ERROR level for others. These will be described in more detail below.

Various embodiments described herein captures log messages when the log message is created inside the application with the aid of a Runtime Instrumentation Engine to monitor application calling the logging framework application programming interfaces (APIs). The Runtime Instrumentation Engine can be in the form of a library or a dynamic-link library (DLL), and can be activated during an early stage of the program initialization to transform any other program code, classes, etc. that are loaded thereafter. The configuration file of the engine can instruct the engine as to what should be transformed, intercepted, or monitored.

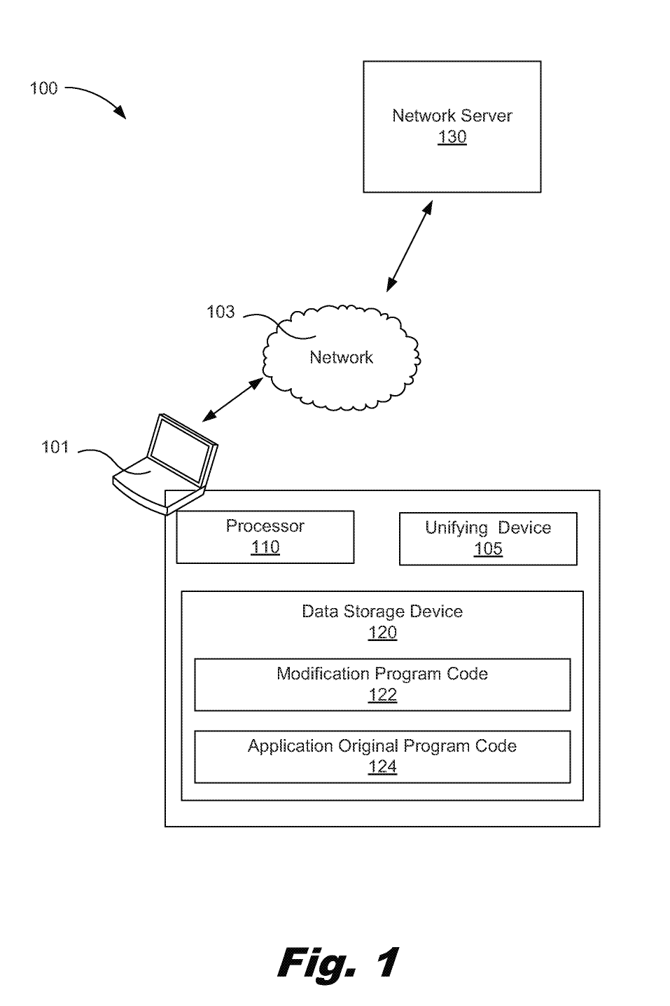

Referring now to the figures, FIG. 1 is a block diagram of an example of a unifying system (100) according to an example of the principles described herein. The system (100) is capable of modifying execution at runtime of an application to capture and unify the log messages. As will be described below, a unifying device (105) captures raw data associated as a log message from program code stored in physical memory in an application on a computing device (101). The unifying device (105) then constructs a log message based on the raw data.

In one example, the system (100) includes a computing device (101). The computing device (101) comprises a processor 110, and a data storage device (120) which comprises computer-readable program code (122, 124) for modifying execution, at runtime, of an application that generates log messages. Computing device (101) may be, for example, a notebook computer, a slate computing device, a server, a desktop, a workstation, or any other computing device. In this example, the computing device stores, in physical memory, program code for an application. In this example, the program code stored in physical memory may be raw data. As mentioned above, raw data may be information in a log message generated by an application. In keeping with the given example, raw data may be program code that has been altered or transformed by another application, program, system, and combinations thereof. As will be described below, a unifying device (105) intercepts an execution of the program code of the application on the computing device (101) at predefined intervals, predefined events, or combinations thereof. Further, the raw data is captured before the raw data is filtered and/or formatted. As a result, the raw data can be constructed into a log message without manually formatting and filtering the log message. More information about the unifying device (105) will be described below.

The processor (110) may comprise a number of central processing units (CPUs), a number of semiconductor-based microprocessors, a number of graphics processing units (CPUs), other hardware devices suitable for retrieval and execution of instructions stored in data storage device (120), or combinations thereof. For example, the processor (110) may include multiple cores on a chip, multiple cores across multiple chips, multiple cores across multiple devices (e.g., if the computing device (101) includes multiple node devices), or combinations thereof. Processor (110) may fetch, decode, and execute computer-readable program code (122, 124) to implement processes and methods described herein. As an alternative or in addition to retrieving and executing instructions, processor (110) may include at least one integrated circuit (IC), other control logic, other electronic circuits, or combinations thereof that include a number of electronic components for performing the functionality of computer-readable program code (122, 124).

The data storage device (120) may be any electronic, magnetic, optical, or other physical storage device that contains or stores executable instructions. Thus, the data storage device (120) may be, for example, Random Access Memory (RAM), an Electrically Erasable Programmable Read-Only Memory (EEPROM), a storage drive, a Compact Disc Read Only Memory (CD-ROM), among other. As such, the data storage device (120) can be non-transitory. As described in detail herein, the data storage device (120) may be encoded with a series of executable instructions for modifying execution at runtime of an application that generates log messages.

Modification program code (122) is computer-readable program code that can be used to implement a real-time modifier. Application original program code (124) is computer-readable program code that can be executed to perform the original functionality of the application. In one example, the modification program code (122) is executed to modify an execution at runtime of the application to capture and unify the log messages.

A network server (130) may also be communicatively coupled to the computing device (101). The network server may receive and store any log messages captured by the system (100) for later use and analysis.

As mentioned above, the system (100) includes a unifying device (105). In one example, the unifying device (105) is in communication with the computing device (101) over a network (103). The unifying device (105) captures raw data associated as a log message from program code stored in physical memory in an application using an application monitoring module. In one example, the application monitoring module is a runtime instrumentation used to check if a particular log level is enabled in a log message or determine if a log message is being written to a log framework. More information about the application monitoring module will be described below. The unifying device (105) then determines if the raw data is to be filtered based on a filtering configuration. Further, the unifying device (105) constructs a log message based on the raw data. As a result, the raw data is captured before the raw data is filtered and formatted to construct a log message. The log message may then be stored in memory on the computing device (101) as a log file. Thus, the unifying device (105) allows the log message to be unified by filtering and formatting the log message in a single format. More information about the unifying device (105) will be described in later sections of the specification.

While this example has been described using a computing device to store program code in physical memory in an application, any appropriate device may be used to store program code in physical memory in an application. For example a server may be used to store in physical memory, program code for an application.

While this example has been described with reference to an application monitoring module being stored in memory in unifying device, the application monitoring module may be stored in any appropriate location. For example, the application monitoring module may be stored may be stored on a server a can be used to monitor an application stored on a computing device. In another example, the application monitoring module may be stored may be stored on a computing device.

While this example has been described with reference to the unifying device (105) being located over a network, the capturing device may be located in any appropriate location according to the principles described herein. For example, the unifying device (105) may be located in a computing device. Further, in one example, the unifying device (105) captures raw data from multiple devices. For example, the unifying device (105) can capture raw data from a server, a laptop, a desktop computer, other device, and combinations thereof. As a result, the raw data is captured before the raw data is filtered and formatted In construct a log message.

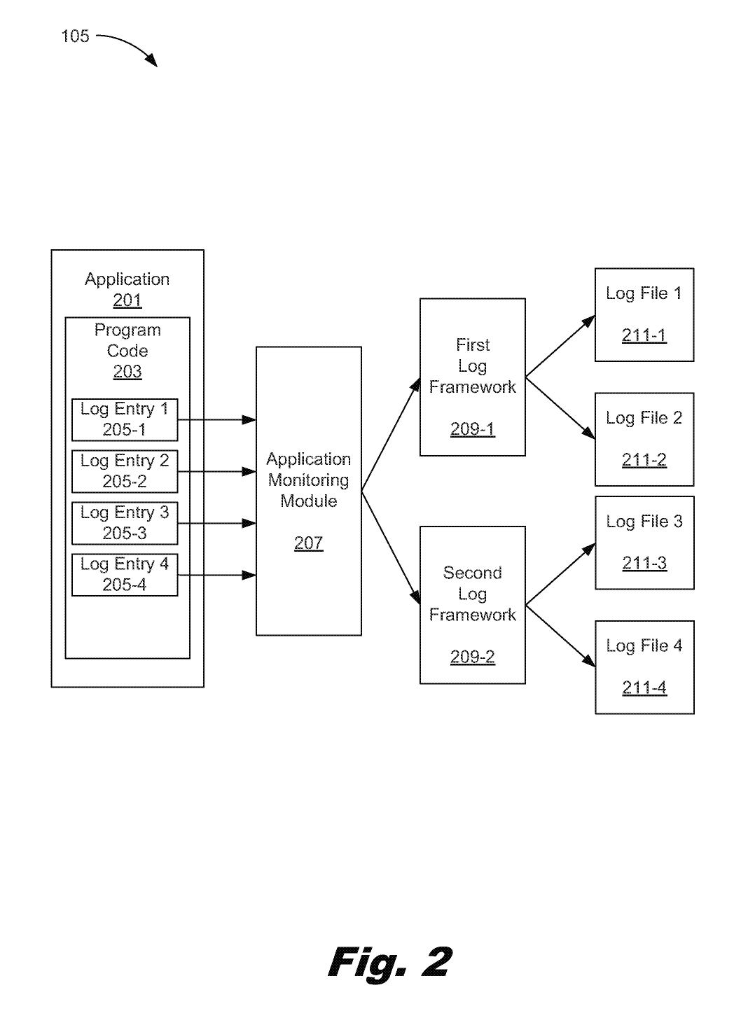

FIG. 2 is a diagram of an example of a unifying device (105), according to the principles described herein. As mentioned above, raw data associated as a log message from program code stored in physical memory in an application is captured using a unifying device (105). Further, the unifying device (105) captures raw data associated as a log message from program code stored in physical memory in an application using an application monitoring module. In one example, the raw data is captured before the raw data is filtered and formatted. As a result, the raw data can be obtained without manually parsing the data stored in at a log storage destination. Further, the unifying device (105) allows all log messages to be unified by filtering and formatting all the log messages in a single format. As a result, it is easier to understand the activity of the computer system.

Turning specifically to FIG. 2, an application (201) includes program code (203). In one example, the program code (203) may be executing on the application (201). In this example, an application monitoring module (207) intercepts the program code (203) while executing on the application (201) at predefined application programming interfaces (APIs). In this example, the application monitoring module (207), intercepts the execution of the program code (203) of the application (201) at predefined events. For example, the predefined events may include log message 1 (205-1), log message 2 (205-2), log message 3 (205-3), and log message 4 (205-4). Although, in this example, the application monitoring module (207) intercepts four log entries (205), the application monitoring module (207) may intercept any appropriate number of log entries. In one example, the predefined event may comprise a log message generation event.

In one example, the unifying device (105) includes a first log framework (209-1) and a second log framework (209-2). As mentioned above, a log framework is highly customizable and can write a log message to a log file in different formats. In this example, the first log framework (209-1) and the second log framework (209-2) can write a log message in different formats. For example, the first log framework (209-1) may write a log message in an XML format while the second log framework (209-2) may write a log message in a JSON format. More information about the formats will be described in later parts of this specification. Further, the first log framework (209-1) has a different API, different parameters, and different filtering mechanisms than a second log framework (209-2). As will be described below and in later parts of the specification, log frameworks can use a format to unify all types of log entries captured inside an application such that the log entries are stored as log files in a single format.

In one example, the application monitoring module (207) monitors when the application (201) is writing a log message to a first log framework (209-1). As mentioned above, the first log framework (209-1) has a different API, different parameters, and different filtering mechanisms than the second log framework (209-2). For example, the application monitoring module (207) intercepts raw data associated as log message 1 (205-1) from program code (203) stored in physical memory in an application (201). In this example, the application monitoring module (207) monitors that an API on the first log framework (209-1) invokes a writing action for log message 1 (205-1). As a result, a writing action is invoked for log message 1 (205-1).

In another, the application monitoring module (207) monitors if an API on the second log framework (209-2) is checking if a particular log level is enabled for a log message (205). In one example, a log level may include an OFF log level, a FATAL log level, an ERROR log level, a WARN log level, an INFO log level, a DEBUG log level, a TRACE log level, or other log levels. Further, a log message may be filtered if a particular log level is enabled. Additionally, a log level may be more severe than another log level. For example, the OFF log level is the least severe and is used to turn logging off.

In one example, the FATAL log level is enabled to indicate that severe errors may cause premature termination of an application. In this example, if the FATAL log level of a log message is less severe than FATAL, the log message may be filtered. In another example, the ERROR log level is enabled to indicate other runtime error or unexpected conditions for an application. In this example, if the log level for a log message is less severe than ERROR, the log message may be filtered.

Depending on the filtering configuration for each log framework, the raw data may be stored as a log file in a number of storage destinations. For example, a storage destination may be a secure server, an unsecured server, other storage destinations, and combinations thereof.

As mentioned above, the application monitoring module (207) monitors if an API on the second log framework (209-2) is checking if a particular log level is enabled. For example, the application monitoring module (207) intercepts raw data associated as log message 2 (205-2) from program code (203) stored in physical memory in an application (201). In this example, the application monitoring module (207) monitors that an API on the second log framework (209-2) is checking if a particular log level is enabled for log message 2 (205-2). As a result, the unifying system (105) can implement a number of filtering configurations and override an original function in log message 2 (205-2).

In keeping with the above example, after log message 1 (205-1) has been captured, the unifying device (105) may determine if the raw data for log message 1 (205-1) should be filtered. As will be described in later parts of the specification, filtering raw data is based on a filtering configuration. In one example, a filtering configuration may be based on whether a particular log level is enabled. Further, if it is determined that the raw data is not to be filtered, a log message is constructed based on the raw data. In this example, the log message is formatted by the first log framework (209-1). The log message for log message 1 (205-1) is stored as log file 1 (211-1). More information about filtering raw data, constructing a log message, and formatting a log message will be described in later parts of the specification. Further, in one example, the log file 1 (211-1) may be stored on a secure server. In another example, the log file 1 (211-1) may be stored on an unsecured server. In yet another example, the log file 1 (211-1) may be stored on a computing device.

In another example, log message 2 (205-2) is captured, filtered, constructed into a log message, and formatted, by the second log framework (209-2). In this example, the log message for log message 2 (205-2) is stored as log file 2 (211-2). As mentioned above, the log file 2 (211-2) may be stored on a secure server, stored on an unsecured server, or stored on a computing device.

Additionally, log message 3 (205-3) and log message 4 (205-4) may be captured, filtered, constructed into a log message, and formatted properly, by the first log framework (209-1) or the second log framework (209-2). Further, log message 3 (205-3) and log message 4 (205-4) are stored as log file 3 (211-3) and log file 4 (211-4), respectively.

While the above example includes two log frameworks, any number of log frameworks may be used in the system (105). For example, the system (105) may include one log framework. In another example, the system (105) may include ten log frameworks.

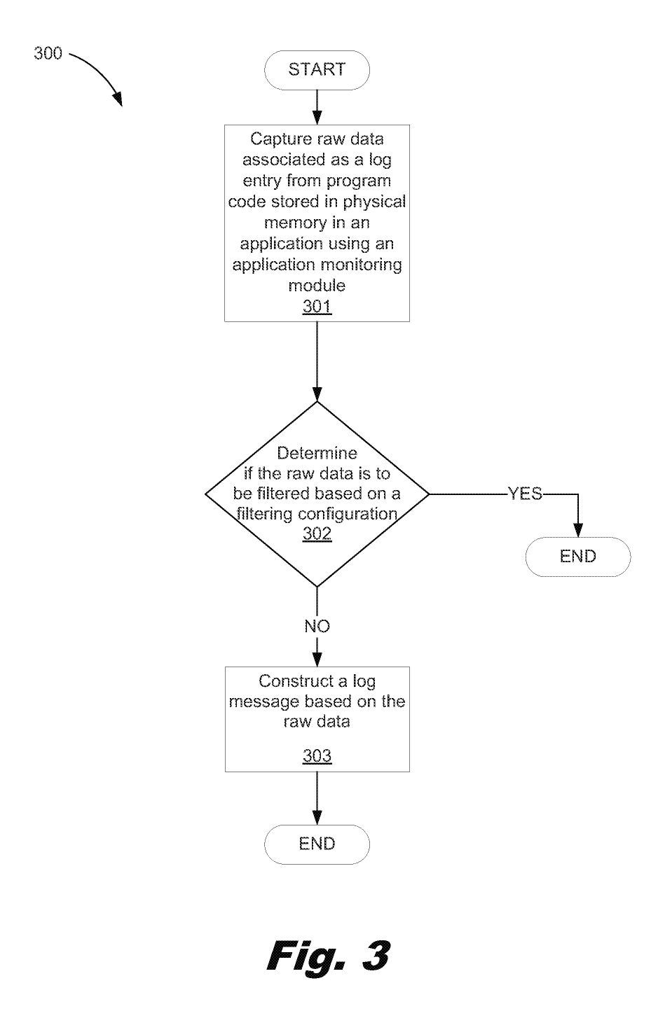

FIG. 3 is a flowchart of an example of a method for unifying a log message in an application, according to one example of principles described herein. The method (300) includes capturing (301) raw data associated as a log message from program code stored in physical memory in an application using an application monitoring module, determining (302) if the raw data is to be filtered based on a filter configuration, and constructing (303) a log message based on the raw data.

Turning specifically to FIG. 3, capturing (301) raw data associated as a log message from program code stored in physical memory in an application using an application monitoring module includes intercepting the program code's raw data while executing on the application at a predefined application programming interfaces (APIs).

Further, capturing raw data associated as a log message from program code stored in physical memory in an application using an application monitoring module includes modifying the program code to allow the unifying device (105) to monitor when the application is writing a log message to a log framework. In one example, the program code is modified in memory on the unifying device (105). In another example, the program code is modified in memory on an application. As mentioned above, the method includes determining (302) if the raw data is to be filtered based on a filter configuration of the unifying device which may or may not be depend on the filter configuration of the log framework. In one example, the filter configuration can be constructed in a number of formats. In this example, a filter configuration can be constructed according to a logger's name. For example, if a logger's name is “com.foo” then a minimum log level is DEBUG. As mentioned above, The DEBUG level is enabled to indicate detailed information on the flow through the system. Further, the DEBUG level is written to log files. In another example, if a logger's name is “com.example,” then the minimum log level is ERROR. As mentioned above, the ERROR level is enabled to indicate other runtime error or unexpected conditions for an application. Further, the minimum log level for all other loggers is INFO. The INFO level is enabled to indicate an interesting runtime event for a startup or shutdown sequence of an application. In this example, loggers are logical log file names that are used in a Java application. Further, each logger is independently configurable as to what level of logging it currently logs. Additionally, as mentioned above, a filter configuration may be constructed according to a log level. In one example, a log level may include an OFF log level, a FATAL log level, an ERROR log level, a WARN log level, an INFO log level, a DEBUG log level, a TRACE log level, other log levels, and combinations thereof. For example, if a log level such as INFO is enabled, then the raw data is to be filtered. Alternatively, if a log level such as INFO is disabled, then the raw data is not to be filtered.

In one example, the log message can be intercepted by using the Runtime Instrumentation Engine to monitor the logging framework APIs. The example includes the following codes:

Logger logger = Logger.getLogger(″com.foo″);
if ( logger.isDebugEnabled( ) ) {
logger.debug(“this is a debug level log message”);
}

In this example, the logger name is explicitly set to “com.foo”, and the program is trying to log a DEBUG level message only if DEBUG is enabled, or will not be filtered, for this logger. Additionally, the present example will use a Runtime Instrumentation Engine to intercept the “logger.isDebugEnabled( )”, forcing the return value to be true if needed and it will intercept the “loggerdebug( . . . )” in order to capture the raw message. The unifying device 005) may also intercept “Logger.getLogger(“com.foo”)” in order to capture the logger name, or can use some other methods, such as reflection calls, to determine the logger name whenever necessary.

In another example, the captured data does not contain the final log message and the invention will construct the final log message from the captured data by performing the same formatting operation on the captured data as by the logging framework. This example includes the following codes:

public class Wombat {

final static Logger logger =
LoggerFactory.getLogger(Wombat.class);
Integer t;
Integer oldT;
public void setTemperature(Integer temperature) {

oldT = t;
t = temperature;
String fmt = “Temperature set to { }. Old temperature
was { }.”;
logger.debug(fmt, t, oldT);
if(temperature.intValue( ) > 50) {

doSomething( );

}

}

}

In this example, the unifying device (105) will capture “fmt”, “t”, and “oldT”, and will construct the final message by using these arguments.

Additionally, if the unifying device (105) determines that raw data is to be filtered based on a filter configuration the method (300) ends. Alternatively, if the unifying device (105) determines that raw data is not to be filtered based on a filter configuration, a log message is constructed.

As mentioned above, the method (300) includes constructing (303) a log message based on the raw data. In one example, raw data that has been captured may not contain a final log message. As a result, constructing a log message may include adding a final log message to a log message. Further, a prefix may not be present in a log message. As a result, a prefix may be added to a log message. More information about constructing a log message will be described below.

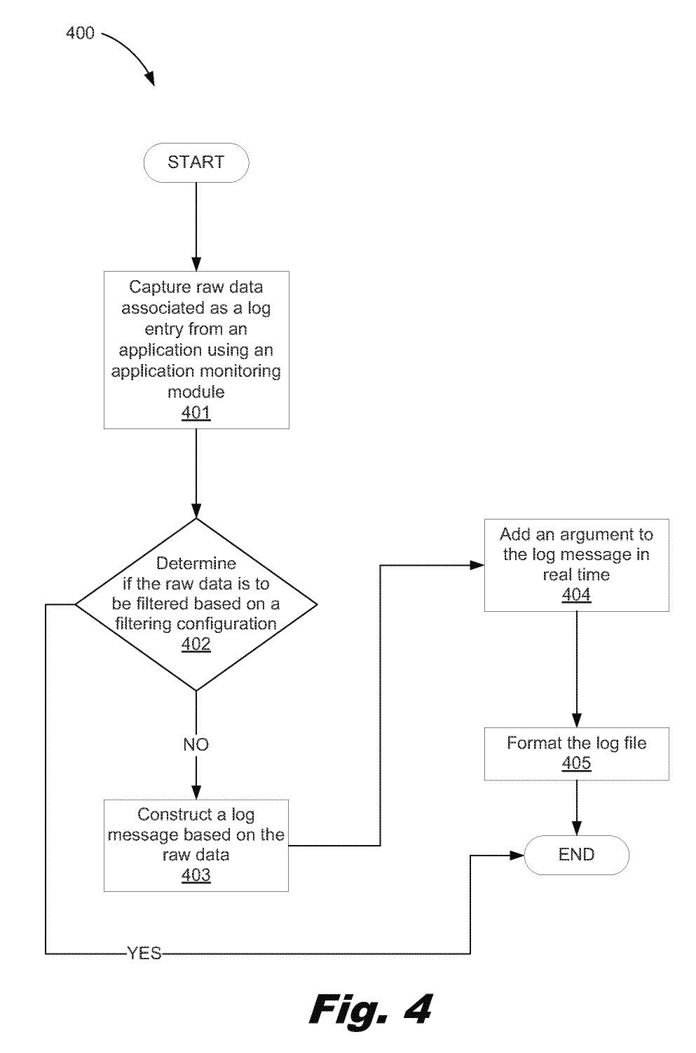

FIG. 4 is a flowchart of an example of a method for capturing raw data from program code in an application, according to one example of principles described herein. The method (400) includes capturing (401) raw data associated as a log message from program code stored in an application using an application monitoring module, determining (402) if the raw data is to be filtered based on a filter configuration, constructing (403) a log message based on the raw data, adding (404) an argument to the log message in real time, and formatting (405) the log message.

Turning specifically to FIG. 4, adding (404) an argument to the log message in real time includes determining if a log message has a final log message. In one example, raw data that has been captured may not contain a final log message. In this example, a final log message may be added to the log message. In one example, adding (404) additional arguments may include adding an argument such as a variable to the log message. In another example, adding (404) additional arguments may include adding an argument such as a conditional statement to the log message. Further, any other appropriate argument may be added to the log message.

As mentioned above, the method (400) includes formatting (405) the log message. In one example, formatting the log message includes adding a prefix to the log message. In one example, a prefix may include a stack trace, a date time, a process identification, or combinations thereof. In one example, adding a stack trace allows the unifying device (105) to include a report of active stack frames at a certain point in time during the execution of program code in an application. Further, adding a date time to the log message allows a user reading the resulting stored log file to determine the date and time when the log file was created. Still further, adding a process identification to the log message allows a user reading the resulting stored log file to identify the process that created the log message. In one example, the process may be identified as a first log framework that created the log message. In another example, the process may be identified as a second log framework that created the log message.

Further, formatting the log message includes formatting the log message in an appropriate format. In one example, all log message may be formatted in an XML format, a JSON format, an ASCII format, other formats, and combinations thereof. As a result, the log message may be unified by formatting the log messages in a single format.

In one example, the XML format is used to emphasize simplicity, generality, and usability over a network. Further, the XML format is used for documents and is widely used to represent arbitrary data structures such as web services. As a result, a log message may be formatted in the XML format.

In another example, the JSON format is a text-based open standard used for human readable data interchanges. Further, the JSON format is used for representing simple data structures and associative arrays of objects. As a result, a log message may be formatted in the JSON format.

In still another example, the ASCII format is a character encoding scheme based on the English alphabet. Further, the ASCII format represents text in computers, communications equipment, and other devices that use text. As a result, a log message may be formatted in the ASCII format.

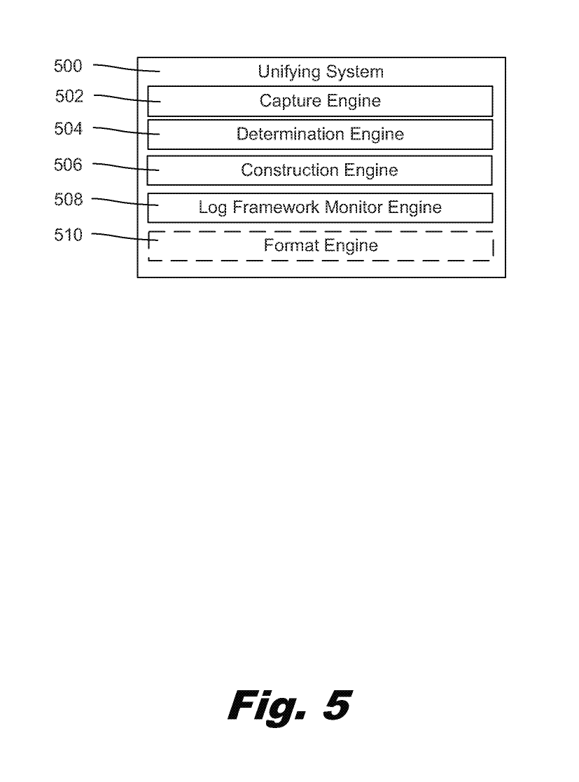

FIG. 5 is a diagram of a unifying system, according to one example of the principles described herein. The unifying system (500) includes a capture engine (502), a determination engine (504), a construction engine (506), and a log framework monitor engine (508). In this example, the unifying system (500) also includes a format engine (510). The engines (502, 504, 506, 508, 510) refer to a combination of hardware and program instructions to perform a designated function. Each of the engines (502, 504, 506, 508, 510) may include a processor and memory. The program instructions are stored in the memory and cause the processor to execute the designated function of the engine.

The capture engine (502) captures raw data associated as a log message from program code stored in physical memory in an application using an application monitoring module. The capture engine further intercepts an execution of the program code's raw data of the application at a predefined interval, at a predefined event, and combinations thereof.

The determination engine (504) determines if the raw data is to be filtered based on a filtering configuration. As mentioned above a filtering configuration may be based on whether a log level is enabled or the log level is disabled. For example, if a log level such as INFO is enable, the raw data is to be filtered. In another example, if a log level such as ERROR is disabled, the raw data is not to be filtered.

The construction engine (506) constructs a log message based on the raw data. As mentioned above, raw data that has been captured may not contain a final log message. In this example, a final log message may be added to the log message. In one example, adding additional arguments may include adding an argument such as a variable to the log message. In another example, adding additional arguments may include adding an argument such as an environment variable to the log message. Further, any other appropriate argument may be added to the log message.

The log framework monitor engine (506) monitors an application program interface that invokes a writing action of a log message using a log framework to capture the log message. Further, the log framework monitor engine (508) monitors an application program interface that checks if a particular log level is enabled on a log message. As mentioned above, a log level may include an OFF level, a FATAL level, an ERROR level, a WARN level, an INFO level, a DEBUG level, a TRACE level, other levels, and combinations thereof. As a result, the log framework monitor engine monitors and checks a number of log levels in the log message. In one example, the log framework monitor engine (506) monitors any and all additional aspects of an application program in addition to the application program interface.

The format engine (510) formats a log message by adding a prefix to the log message. As mentioned above, a prefix may include a stack trace, a date time, a process identification, or combinations thereof. Further, the format engine (510) unifies each log message. As a result, each log message is formatted in a single format.

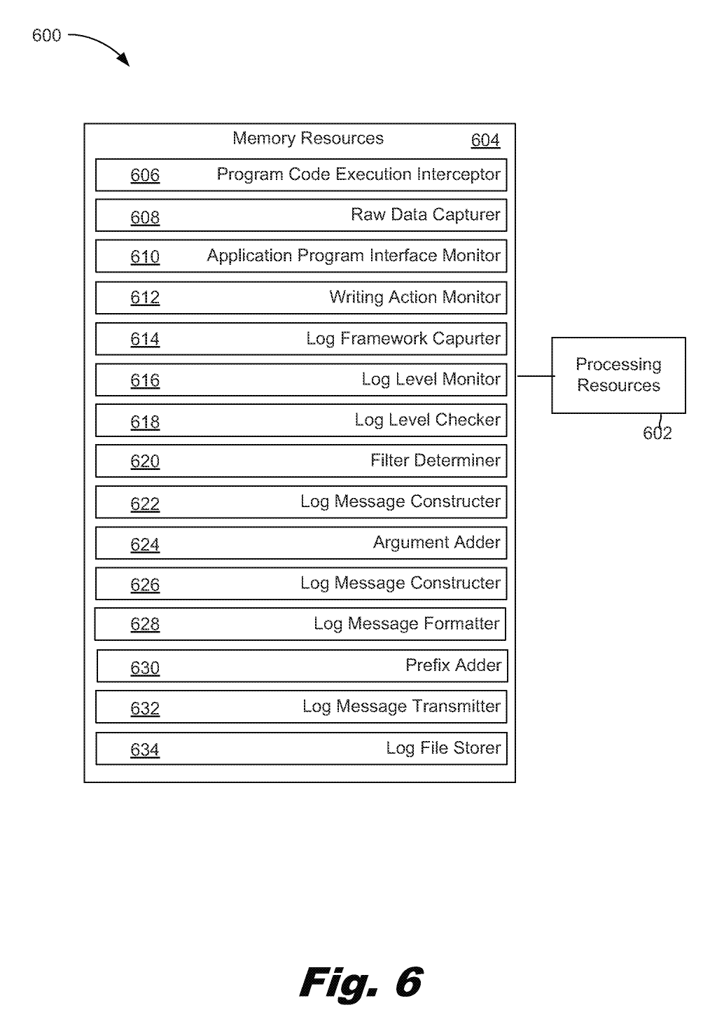

FIG. 6 is a diagram of an example of a unifying system, according to the principles described herein. In this example, unifying system (600) includes processing resources (602) that are in communication with memory resources (604). Processing resources (602) include at least one processor and other resources used to process programmed instructions. The memory resources (604) represent generally any memory capable of storing data such as programmed instructions or data structures used by the unifying system (600). The programmed instructions shown stored in the memory resources (604) include a program code execution interceptor (606), a raw data capturer (608), an application program interface monitor (610), a writing action monitor (612), a log framework capturer (614); a log level monitor (616), a log level checker (618), a filter determiner (620), a log message constructer (622), an argument adder (624), a log message constructer (626), log message formatter (628), a prefix adder (630), a log message transmitter (632), a log file sharer (634).

The memory resources (604) include a computer readable storage medium that contains computer readable program code to cause tasks to be executed by the processing resources (602). The computer readable storage medium may be tangible and/or physical storage medium. The computer readable storage medium may be any appropriate storage medium that is not a transmission storage medium. A non-exhaustive list of computer readable storage medium types includes non-volatile memory, volatile memory, random access memory, write only memory, flash memory, electrically erasable program read only memory, or types of memory, or combinations thereof.

The program code execution interceptor (606) represents programmed instructions that, when executed, cause the processing resources (602) to intercept program code executing on an application. The raw data capturer (608) represents programmed instructions that, when executed, cause the processing resources (602) to capture raw data associated as a log message from program code stored in physical memory in an application. The application program interface monitor (610) represents programmed instructions that, when executed, cause the processing resources (602) to monitor an application program interface. The write action monitor (612) to monitor a write action for a log message. The log framework capturer (614) represents programmed instructions that, when executed, cause the processing resources (602) to capture raw data associated as a log message using a log framework. The log level monitor (616) represents programmed instructions that, when executed, cause the processing resources (602) to monitor a log level. The log level checker (618) represents programmed instructions that, when executed, cause the processing resources (602) to check if a log level is enabled for a log message.

The filter determiner (620) represents programmed instructions that, when executed, cause the processing resources (602) to determine if raw data is to be filtered. The log message constructer (622) represents programmed instructions that, when executed, cause the processing resources (602) to construct a log message. The argument adder (624) represents programmed instructions that, when executed, cause the processing resources (602) to add an argument to a log message. The file log constructer (626) represents programmed instructions that, when executed, cause the processing resources (602) to construct a file log based on the log message. The log message formatter (628) represents programmed instructions that, when executed, cause the processing resources (602) to format a log message. The prefix adder (630) represents programmed instructions that, when executed, cause the processing resources (602) to add a prefix to a log message. The log message transmitter (632) represents programmed instructions that, when executed, cause the processing resources (602) to transmit a log message. The log file storer (634) represents programmed instructions that, when executed, cause the processing resources (602) to store a log message as a log file in memory.

Further, the memory resources (604) may be part of an installation package. In response to installing the installation package, the programmed instructions of the memory resources (604) may be downloaded from the installation package's source, such as a portable medium, a server, a remote network location, another location, or combinations thereof. Portable memory media that are compatible with the principles described herein include DVDs, CDs, flash memory, portable disks, magnetic disks, optical disks, other forms of portable memory, or combinations thereof. In other examples, the program instructions are already installed. Here, the memory resources can include integrated memory such as a hard drive, a solid state hard drive, or the like.

In some examples, the processing resources (602) and the memory resources (602) are located within the same physical component, such as a server, or a network component. The memory resources (604) may be part of the physical component's main memory, caches, registers, non-volatile memory, or elsewhere in the physical component's memory hierarchy. Alternatively, the memory resources (604) may be in communication with the processing resources (602) over a network. Further, the data structures, such as the libraries, may be accessed from a remote location over a network connection while the programmed instructions are located locally. Thus, the unifying system (600) may be implemented on a computing device, on a server, on a collection of servers, or combinations thereof.

The unifying system (600) of FIG. 6 may be part of a general purpose computer. However, in alternative examples, the unifying system (600) is part of an application specific integrated circuit.

Aspects of the present system and method are described herein with reference to flowchart illustrations and/or block diagrams of methods, apparatus (systems) and computer program products according to examples of the principles described herein. Each block of the flowchart illustrations and block diagrams, and combinations of blocks in the flowchart illustrations and block diagrams, may be implemented by computer usable program code. The computer usable program code may be provided to a processor of a general purpose computer, special purpose computer, or other programmable data processing apparatus to produce a machine, such that the computer usable program code, when executed via, for example, a processor on the unifying system (FIG. 1, 105) or other programmable data processing apparatus, implement the functions or acts specified in the flowchart and/or block diagram block or blocks. In one example, the computer usable program code may be embodied within a computer readable storage medium; the computer readable storage medium being part of the computer program product. In one example, the computer readable storage medium is a non-transitory computer readable medium.

The preceding description has been presented to illustrate and describe examples of the principles described. This description is not intended to be exhaustive or to limit these principles to any precise form disclosed. Many modifications and variations are possible in light of the above teaching.

What is claimed is:

1. A method for unifying application log messages using runtime instrumentation, the method comprising:
capturing raw data associated as a log message from an application using an application monitoring module;
determining if said raw data is to be filtered based on a filtering configuration; and
constructing a log message based on said raw data.

2. The method of claim 1, in which capturing said raw data associated as said log message from said application using said application monitoring module comprises intercepting an execution of program code of said application at a log message generation event.

3. The method of claim 1, further comprising monitoring an application program interface that invokes a writing action of said log message using at least one log framework to capture said log message.

4. The method of claim 3, further comprising modifying program code of said application to allow said application monitoring module to monitor when said application is writing said log message via the at least one said log framework.

5. The method of claim 4, further comprising monitoring at least one log level on said log message using at least one said log framework to determine said filter configuration,
in which said filter configuration comprises determining if a number of log levels are enabled or disabled in the log message and filtering the log message if a predetermined log level is enabled allowing the system to implement a different filtering mechanism than the filtering mechanisms associated with the application.

6. The method of claim 1, in which constructing said log message based on said raw data comprising adding an argument to said log message in real time.

7. The method of claim 6, further comprising formatting said log message,
in which formatting said log message comprises adding a prefix to said log message, and
in which said prefix comprises a stack trace, a date time, a process identification, or combinations thereof.

8. A system for unifying application log messages using runtime instrumentation, the system comprising:
a capture engine to capture raw data associated as a log message from an application using an application monitoring module;
a determination engine to determine if said raw data is to be filtered based on a filtering configuration;
a construction engine to construct a log message based on said raw data; and
a log framework monitor engine to monitor an application program interface that invokes a writing action of said log message using at least one log framework to capture said log message in real time.

9. The system of claim 8, in which said construction engine further constructs a log message by adding an argument to said log message in real time.

10. The system of claim 9, further comprising a format engine to format said log message,
in which said format engine adds a prefix to said log message, and
in which said prefix comprises a stack trace, a date time, a process identification, or combinations thereof.

11. The system of claim 8, in which said log framework monitor engine further monitors a log level using said at least one log framework to determine said filter configuration.

12. The system of claim 8, in which said capture engine further intercepts an execution of said program code of said application at a predefined event.

13. A computer program product for unifying application log messages using runtime instrumentation, comprising:
a tangible non-transitory computer readable storage medium, said tangible non-transitory computer readable storage medium comprising computer readable program code embodied therewith, said computer readable program code comprising program instructions that, when executed, causes at least one processor to:
capture raw data associated as a log message from an application when the application invokes a predetermined application programming interface using an application monitoring module; and
construct a log message based on said raw data.

14. The computer program product of claim 13, further comprising computer readable program code comprising program instructions that, when executed, cause said processor to intercept an execution of program code of said application at a predefined event associated with an invocation of a write action associated with the application programming interface.

15. The computer program product of claim 13, further comprising computer readable program code comprising program instructions that, when executed, cause said processor to construct the log message by adding an argument to said raw data in real time.
